(19) United States
(12) Patent Application Publication
(10) Pub. No.: US 2025/0164869 A1
(43) Pub. Date: May 22, 2025

(54) TEST ARRANGEMENT AND METHOD FOR STIMULATING AN INFRARED CAMERA-BASED SURROUNDINGS DETECTION SYSTEM

(71) Applicant: dSPACE GmbH, Paderborn (DE)

(72) Inventors: Noel NOTTBECK, Paderborn (DE); Henry BATHKE, Paderborn (DE)

(73) Assignee: dSPACE GmbH, Paderborn (DE)

(21) Appl. No.: 18/950,838

(22) Filed: Nov. 18, 2024

(30) Foreign Application Priority Data
Nov. 16, 2023 (DE) 10 2023 131 900.0

(51) Int. Cl. G03B 43/00; G01M 11/02

(52) U.S. Cl. CPC G03B 43/00; G01M 11/0214; G01M 11/0257

(57) ABSTRACT

A test arrangement for stimulating an infrared camera-based surroundings detection system for test purposes. Included is a holding device in which an infrared camera is fixable as a test object. An infrared light source and a computer-controlled imaging device are also provided. The infrared light source, the imaging device, and the recording device are arranged in such a way that an optical path leads from the light source, through the computer-controlled imaging device, to the test object.

This nonprovisional application claims priority under 35 U.S.C. § 119 (a) to German Patent Application No. 10 2023 131 900.0, which was filed in Germany on Nov. 16, 2023, and which is herein incorporated by reference.

### BACKGROUND OF THE INVENTION

### Field of the Invention

The invention relates to a test stand for stimulating a surroundings detection system that operates using infrared cameras, and to a method for stimulating an infrared camera-based surroundings detection system.

### Description of the Background Art

Vehicles with advanced driver assistance systems (ADASs), for example for autonomous and semiautonomous driving, may include various sensors, for example cameras, radar sensors, ultrasonic sensors, and/or lidar sensors, for the surroundings detection. A camera may be designed as a near infrared camera, for example.

A variant of driver assistance systems focuses on driver monitoring systems. High-resolution infrared cameras that are optimized for the near infrared range are being increasingly used for this purpose. Driver monitoring systems are part of the safety-critical systems, and as such require thorough evaluation in order to prevent malfunctions to the greatest extent possible during use. This evaluation of the sensor system preferably takes place before a vehicle is road-tested. Road tests are costly, complicated, and risky.

Within the scope of hardware-in-the-loop testing, it has become customary to integrate the control device, to be tested, into a simulated context so that it is as untouched as possible, i.e., to operate it in a closed control loop with real time-based surroundings simulation and vehicle simulation. For active surroundings sensors such as radar or lidar sensors, for this purpose target simulators are used which receive the scanning signal of the sensor to be tested, and send back a simulated or manipulated echo signal. For passive sensors such as cameras, for example, for this purpose so-called camera boxes are known which are able to play back simulated settings for stimulating the sensor. It is advantageous that the real sensor as a whole is in use, and it is not necessary to clear interfaces or activate test stand modes.

If such a target simulator is not available, the sensor data may be simulated at the electrical signal level and fed into the signal processing chain of the sensor, behind the actual sensor front end. It is disadvantageous that the entire processing chain cannot be tested.

While approaches are known for cameras in the visible range, for cameras in the infrared or near infrared range it is not possible to stimulate on the optical level, since devices for generating high-resolution near infrared images are not presently known. The object of the invention is to refine the prior art.

### SUMMARY OF THE INVENTION

It is therefore an object of the invention to provide a test arrangement and a method for stimulating an infrared camera-based surroundings detection system.

In an example, the test arrangement comprises a holding device in which an infrared camera is fixable as a test object, an infrared light source, and a computer-controlled imaging device. The infrared light source, the imaging device, and the recording device are arranged in such a way that an optical path leads from the light source, through the computer-controlled imaging device, to the test object. This allows the light source to be used in a targeted manner, and the emitted light to be channelized, in order to stimulate the test object. Further imaging elements such as polarizers, lenses, collimators, or the like may be provided between the light source and the imaging device, or between the imaging device and the test object. The imaging device is computer-controlled.

The computer-controlled imaging device can be provided by a computer-controlled matrix having matrix elements. At least one matrix element is activatable in such a way that the optical path through the matrix element is selectively passable or blocked. Multiple rows and columns of matrix elements may be provided here which are arranged in such a way that they are illuminated by the light source, and the light in the passable state can strike the test object. It is thus possible to easily provide a device that enables a complex light pattern for testing the infrared camera.

It is thus advantageous for each matrix element to be individually activatable, independently of other matrix elements, so that these activated matrix elements emit light, which is received by the test object. This takes place regardless of the actual light source, which may be an array of infrared LEDs or infrared laser LEDs, for example. Exactly one light beam is then emitted by each of the matrix elements.

The matrix elements can have at least one first state in which the optical path is passable or continuous, and a second state in which the optical path is blocked or noncontinuous. For this purpose, it is provided that the matrix elements have darkening elements for mechanical blocking, which are selectively situated in or outside the optical path.

The matrix elements can have polarization filters which have a selective opening or blocking action as a result of rotation of the polarization direction, and which thus allow selective blocking.

The matrix elements can have mirror elements. The mirror elements can be selectively settable in such a way that either the light from the light source is reflected onto the test object and the optical path is thus passable, or that the light is reflected from the light source into a light trap. The latter option results in blocking of the optical path. The mirror elements may be designed, for example, as micromirrors, also known as digital micromirror devices, or in general as microelectromechanical system (MEMS) mirrors.

The infrared light source can be provided by an infrared laser. The infrared laser emits an essentially bundled, i.e., approximately parallelized, laser beam. In addition, it is provided that the imaging device is provided by a laser deflector which selectively images the laser beam onto the infrared camera in a raster process, or blocks the laser beam. The laser deflector may be implemented as a galvanometer scanner or by use of MEMS systems.

A computer may be installed in the test arrangement. The computer can be configured to send, as specified by a control program that is executable on the computer, control signals to the imaging device or the computer-controlled matrix in order to selectively activate or deactivate matrix elements. The transmission of the control signals takes place by means of an operative connection, which in particular is a data interface. The operative connection is respectively established between the computer or the control device, and the imaging device or the computer-controlled matrix.

The computer or a second computer can carry out a surroundings simulation from the view of the test object, which computes virtual objects in the surroundings in the visual range of the test object. The computer carrying out the surroundings simulation is also configured, based on the virtual objects in the surroundings, to send control signals to the matrix or to output instructions to the first computer for sending control signals to the matrix. This may also take place using a programmable control device. The computer or the programmable control device is configured to activate selected matrix elements, according to a control program kept on the computer or the control device, in such a way that that the matrix elements are passable. For this purpose, the computer or the control device has a data memory.

The test arrangement according to the invention is thus configured to represent one or more virtual objects in the surroundings and provide them for stimulation of the infrared camera. It may be provided that there is a connection between the computer, which carries out the surroundings simulation, and the test object. In addition to the surroundings simulation, a simulation of a test vehicle, of the test driver, and of the vehicle dynamics of the test vehicle may also take place. By means of the above-mentioned connection, the control loop may be closed so that stimulation within the scope of a closed-loop simulation may take place. The response by the test object may be detected in the form of sensor data and control signals, for example, and used for the next simulation step.

The invention further relates to a method for stimulating an infrared camera-based surroundings detection system. The following method steps are provided: arranging a holding device and fixing an infrared camera as a test object in the holding device, and arranging an infrared light source and a computer-controlled matrix having matrix elements, so that an optical path is selectively passable or blocked upon activation of the matrix elements, and wherein it is further provided to arrange the infrared light source, the matrix, and the recording device in such a way that the optical path leads from the light source, through at least one matrix element of the computer-controlled matrix, to the test object.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic view of a design of the test arrangement according to the invention;

FIG. 2 shows a schematic view of a design of the test arrangement according to the invention;

FIG. 3 shows a schematic view of a design of the test arrangement according to the invention;

FIG. 4 shows a schematic view of an example of the computer-controlled matrix; and

FIG. 5 shows a schematic view of an example of the computer-controlled matrix.

### DETAILED DESCRIPTION

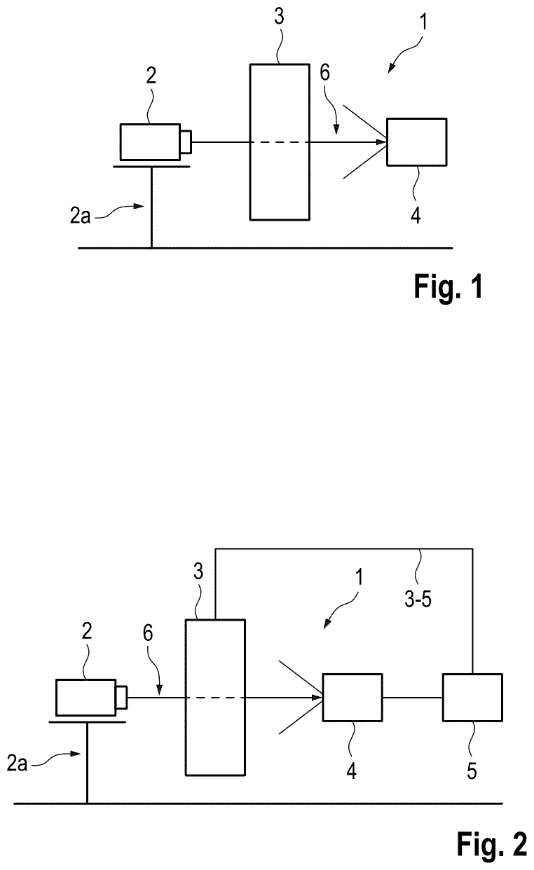

FIG. 1 shows an infrared camera, which as a test object 2 is situated in the test arrangement 1 according to the invention. It is understood that the test object 2 is not part of the test arrangement. The illustration has been selected only to clarify the overall system during the test operation. The test arrangement 1 also includes a holding device 2a for arranging the test object 2. This holding device may be designed in various ways; the exact design is to be adapted to the design of the selected test object 2. In the simplest case, the holding device 2a is a simple plate on which the test object 2 rests. The test arrangement 1 also includes an infrared light source 4 and an imaging device 3. The above-mentioned visual connection results when an optical path 6 leads from the infrared light source 4, through the imaging device 3, to the test object 2. The holding device 2a and the further components of the test arrangement 1, imaging device, 3 and infrared light source 4 are arranged relative to one another so that a visual connection exists between the detector of the test object 2 and the imaging device as well as the light source 4. The imaging device 3 is computer-controlled, so that it is transparent, at least in part, in a targeted manner and is impassable, at least in part, in a targeted manner for the light of the light source 4.

The test arrangement according to the invention is apparent in another example in FIG. 2. In addition to the components already shown, this arrangement also includes a computer 5 which has an operative connection 3-5 with the imaging device 3. In the simplest case, the computer 5 is a control device and the signal connection 3-5 is a data interface. The latter can send control signals to the imaging device, the control signals controlling what portion of the imaging device 3 is to be transparent, and what portion is to be impassable.

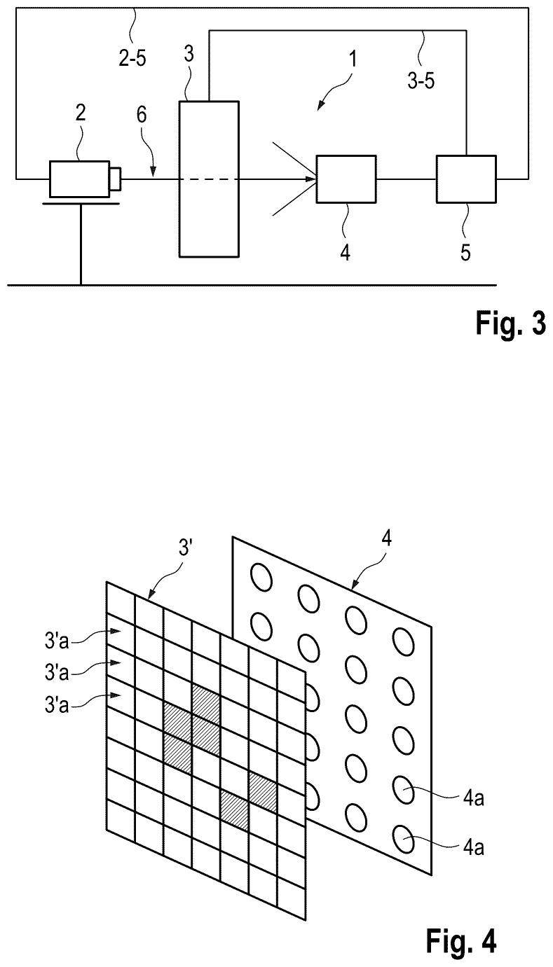

The test arrangement according to the invention also allows stimulation of the test object in a closed loop. This example is shown in FIG. 3. Here, there is a further signal connection 2-5 between the computer 5 and the test object 2. The computer 5 may be provided to simulate the surroundings of the test object. For this purpose it is possible to model, for example, the surroundings of a vehicle using objects in the surroundings, or a driver who is to be observed by the test object, i.e., an infrared camera. In addition, the vehicle in which the test object is normally installed and the vehicle dynamics may be modeled. The objects in the surroundings that are specified by the surroundings simulation are now to be observed and recognized by the test object. For this purpose, the simulated situation may be represented on the imaging device, wherein the individual pixels are activated by the objects in the surroundings that are specified by the simulation. It may thus be checked whether the test object is showing the expected response. For example, automatic braking may take place. The response by the test object may be sent back to the computer 5 via the signal connection 2-5, and the execution of the simulation may be influenced. However, it is also possible for there to be no closed loop, and for the response by the test object to be merely recorded or read out, for example.

FIG. 4 shows an example of the imaging device 3 according to the invention. In this example, the imaging device may be designed as a computer-controlled matrix 3′. A matrix may be provided that is made up of matrix elements 3′a which are individually activatable, and which by activation may assume the states “passable” and “impassable.” Furthermore, it is provided that illumination with an infrared light source 4 is provided behind the matrix, which is represented here by individual light sources 4a distributed over a surface area that approximately corresponds to the surface area of the matrix.

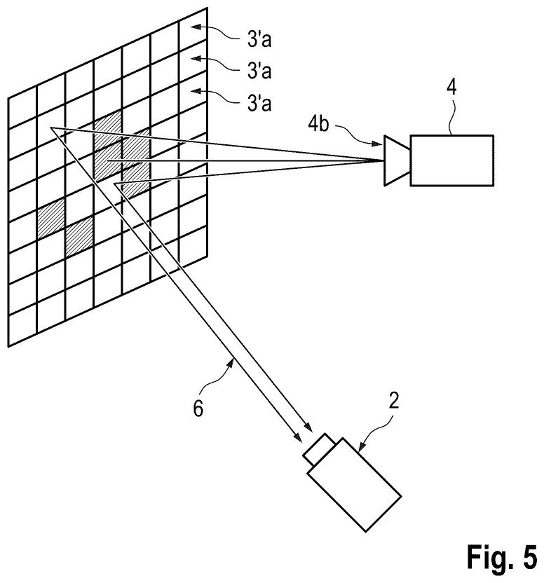

A further example is illustrated in FIG. 5. Here, the matrix 3 is illuminated from the front. The light source 4 here may be a laser or laser LED 4b or also an IR diode 4a. It may be provided to collimate or focus the light source through lenses. The matrix elements 3′a are represented here by reflective elements such as micromirrors. These reflective elements may be individually activated and may assume at least two alignment positions. It is advantageous to select one of the positions so that the light of the light source is reflected to the test object. Another position is to be selected so that the light is not reflected to the test object, and is reflected into a light trap, for example.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A test arrangement to stimulate an infrared camera-based surroundings detection system for test purposes, the test arrangement comprising:
a holding device in which an infrared camera is fixable as a test object;
an infrared light source; and
a computer-controlled imaging device,
wherein the infrared light source, the imaging device, and the camera are arranged in such a way that an optical path leads from the light source, through the computer-controlled imaging device, to the test object.

2. The test arrangement according to claim 1, wherein the computer-controlled imaging device is provided by a computer-controlled matrix having matrix elements, and wherein at least one matrix element is activatable in such a way that the optical path through the matrix element is selectively passable or blocked.

3. The test arrangement according to claim 2, wherein the matrix elements have at least one first state in which the optical path is passable, and a second state in which the optical path is blocked, and wherein the matrix elements have darkening elements for mechanical blocking, which are selectively situated in or outside the optical path.

4. The test arrangement according to claim 2, wherein the matrix elements have at least one first state in which the optical path is passable, and a second state in which the optical path is blocked, and wherein the matrix elements have polarization filters which have a selective opening or blocking action as a result of rotation of the polarization direction.

5. The test arrangement according to claim 2, wherein the matrix elements have at least one first state in which the optical path is passable, and a second state in which the optical path is blocked, and wherein the matrix elements have mirror elements which selectively make the optical path passable, or bring about blocking of the optical path and deflection into a light trap.

6. The test arrangement according to claim 1, wherein the infrared light source is provided by an infrared laser that outputs an essentially bundled laser beam, and the imaging device is provided by a laser deflector that selectively images the laser beam onto the infrared camera in a raster process, or blocks the laser beam.

7. The test arrangement according to claim 1, further comprising a computer configured to send, as specified by a control program that is executable on the computer, control signals to the computer-controlled matrix in order to selectively activate or deactivate matrix elements.

8. The test arrangement according to claim 7, wherein the computer or a second computer carries out a surroundings simulation from the view of the test object, which computes virtual objects in the surroundings in the visual range of the test object, and the computer is also configured, based on the virtual objects in the surroundings, to send control signals to the matrix or to output instructions to the first computer for sending control signals to the matrix.

9. A method for stimulating an infrared camera-based surroundings detection system, the method comprising:
arranging a holding device;
fixing an infrared camera as a test object in the holding device;
arranging an infrared light source and a computer-controlled matrix having matrix elements, so that an optical path is selectively passable or blocked upon activation of the matrix elements; and
arranging the infrared light source, the matrix, and the infrared camera such that the optical path leads from the light source, through at least one matrix element of the computer-controlled matrix, to the test object.
